(19) United States
(12) Patent Application Publication
(10) Pub. No.: US 2011/0231868 A1
(43) Pub. Date: Sep. 22, 2011

(54) On-Line Video Entertainment and Advertising System and Method for Using the Same

(75) Inventor: Aaron Martens, Cave Creek, AZ (US)

(73) Assignee: (N)TORUS TECHNOLOGIES, Scottsdale, AZ (US)

(21) Appl. No.: 12/859,689

(22) Filed: Aug. 19, 2010

Related U.S. Application Data
(60) Provisional application No. 61/274,586, filed on Aug. 19, 2009.

(51) Int. Cl. H04H 60/33; H04N 7/16

(52) U.S. Cl. 725/13; 725/23

(57) ABSTRACT

A method of providing video entertainment content on-line without advertising interruptions of the video entertainment content is provided. A user request to provide video entertainment content is received. An amount of credits required to display the entertainment content is determined. The user is informed of the amount of credits required to view the video entertainment content. A list of advertisements the user may watch to earn credits is provided. It is determined whether the user has watched an advertisement and earned credits. The user is allowed access to the video entertainment content without advertising interruptions when the user has the amount of credits required to display the entertainment content.

### CROSS-REFERENCE TO RELATED APPLICATIONS

This application claims priority to U.S. Provisional Patent Application No. 61/274,586 filed on Aug. 19, 2009 which is herein incorporated by reference in its entirety.

### FEDERALLY SPONSORED RESEARCH OR DEVELOPMENT

Not Applicable.

### TECHNICAL FIELD

The present invention relates generally to a system and method for providing on-line video entertainment and advertising for use with on-line video content distribution.

### BACKGROUND OF THE INVENTION

Consumers of entertainment content, sports content, news content, and the like, collectively “entertainment content,” continue to search for improved ways that allow them to view this content in a manner that fits into their busy schedule. In the past, consumers utilized a video cassette recorder (“VCR”) to record programming that aired on television, and watch the recordings when their schedule allowed, a concept often referred to as “time-shifting.” Time-shifting allowed a user to shift the time they watched a program away from the scheduled time that it aired, to a time more convenient to the user when they could watch the VCR recording of the program. More recently, the digital video recorder (“DVR”) has replaced the VCR as the preferred method for consumers to time-shift television programming. The time-shifting approach of recording satisfied consumers desire to watch content when it fit their schedule, but it requires users to actively choose content to record. Thus, sometimes consumers forget to set a recording of the content they wish to record, or find the process of recording content difficult or frustrating. Time-shifting is less satisfying to advertisers, since consumers often fast forward through advertising content that was intermixed with the desired content the user recorded.

More recently, as more consumers have obtained high-speed internet services, content providers have started on-line streaming video over the internet so that consumers can watch desired content when their schedule allows. For example, television networks such as CBS, NBC, ABC, and FOX all allow users to watch complete episodes of television shows appearing on their networks over the internet. Providing streaming video of content allows a content provider, such as a television network, a movie studio, a television production company, and the like, to allow consumers to conveniently watch the content, while also allowing the content provider to generate revenue by placing advertisements in the stream. Additionally, the stream may be set so that a user is not allowed to fast forward through advertisements. However, interruptions in the desired content by advertisements lead to user dissatisfaction. Surveys have shown that about 60% of users are annoyed by advertisements placed in the streaming content, and that 20% of users avoid websites that have advertisements within the streaming content.

Further, if a user does not fall into a demographic group targeted by advertisements in the stream, the advertiser is not receiving the full value they desire for that advertisement. Thus, an advertisement that is placed in streaming content for an automobile will not likely interest a person who does not drive, and therefore the automobile company did not receive value for placing this advertisement before that particular viewer.

Thus, it would be useful to provide an on-line video content and advertising system that allows a user to watch desired content without advertisements interrupting the desired content, and also allows advertisers to target their advertisements to user's likely to have an interest in the advertised products.

The present invention is provided to solve the problems discussed above and other problems, and to provide advantages and aspects not previously provided. A full discussion of the features and advantages of the present invention is deferred to the following detailed description, which proceeds with reference to the accompanying drawings.

### SUMMARY OF INVENTION

The present invention generally provides an on-line video entertainment and advertising system allowing a user to view entertainment content without advertising interruption by watching advertising content independently to collect credits that may be redeemed to watch advertising-free entertainment content.

According to one process, a method of providing video entertainment content on-line without advertising interruptions of the video entertainment content is provided. A user request to provide video entertainment content is received. An amount of credits required to display the entertainment content, advertising free, is determined. The user is informed of the amount of credits required to view the video entertainment content. A list of advertisements the user may watch to earn credits is provided. It is determined whether the user has watched an advertisement and earned credits. The user is allowed access to the video entertainment content without advertising interruptions when the user has the amount of credits required to display the entertainment content.

According to another process, a method of controlling advertising content for an on-line video entertainment and advertising system providing video entertainment content without advertising interruptions is provided. A video advertisement is stored within a memory associated with an on-line video entertainment and advertising system. An input is received indicative of a number of credits to provide a user that watched the video advertisement. A time period is scheduled when the video advertisement is available for viewing. Questions to ask a user each time a user watched the video advertisement are received. User targeting information for the video advertisement is received.

According to one embodiment, a physical computer program product that comprises a computer usable medium having an executable computer readable program code embodied therein is provided. The executable computer readable program code implements a method the provides entertainment content over a computer network. The method receives a user input selecting video entertainment content to provide. It is determined if a user has sufficient advertising viewing credits to view the selected video entertainment content selected without viewing advertising during a presentation of the entertainment content. Access of the video entertainment content is presented to the user without advertising if the user has sufficient advertising viewing credits. A message to the user of an amount of advertising viewing credits needed to view the video entertainment content without viewing advertising during a presentation of the video entertainment content is generated if the user lacks sufficient credits. The user is allowed to accumulate additional advertising viewing credits if the user lacks sufficient advertising viewing credits to view the video entertainment content without viewing additional advertising during the presentation of the entertainment content.

Other features and advantages of the invention will be apparent from the following specification taken in conjunction with the following drawings.

### BRIEF DESCRIPTION OF THE DRAWINGS

FIG. 1 is a schematic diagram of an on-line video entertainment and advertising system according to one embodiment;

FIG. 2 is a flow chart showing a method of using a user interface operating an on-line video entertainment and advertising system;

FIG. 3 is a flow chart showing another method of using a user interface operating an on-line video entertainment and advertising system;

FIGS. 4A-4C is a flow chart showing a method of using an advertiser interface operating an on-line video entertainment and advertising system.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

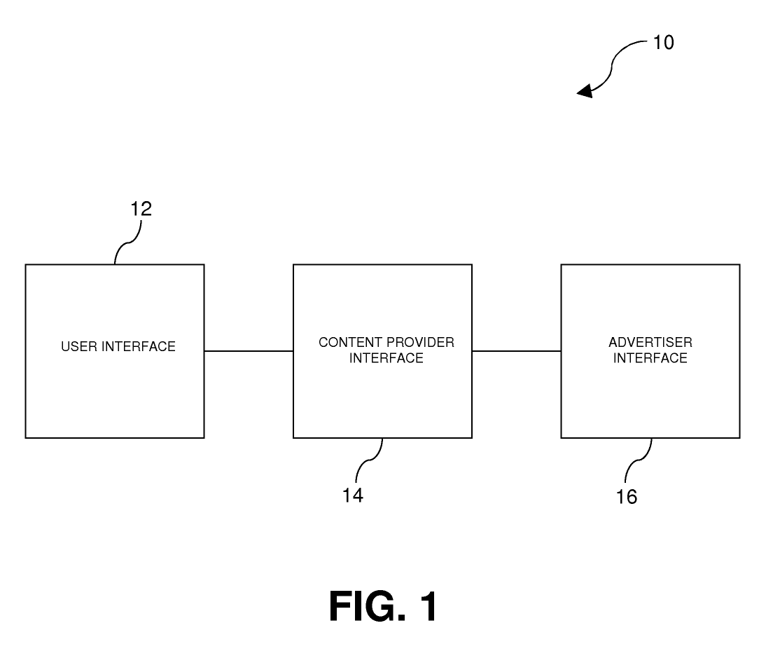

FIG. 1 shows a schematic diagram of an on-line video entertainment and advertising system 10 according to one embodiment. The on-line video entertainment and advertising system 10 comprises a user interface 12, a content provider interface 14 and an advertiser interface 16. The user interface 12 allows a user to select content that they wish to view on-line from the selections made available by a content provider. The content provider interface 14 allows a content provider to make certain content available to a user. The advertiser interface 16 allows an advertiser to select which advertisements are made available to a user, the order that advertisements are shown to the user, a period of time when specific advertisements are shown to a user, among other functions.

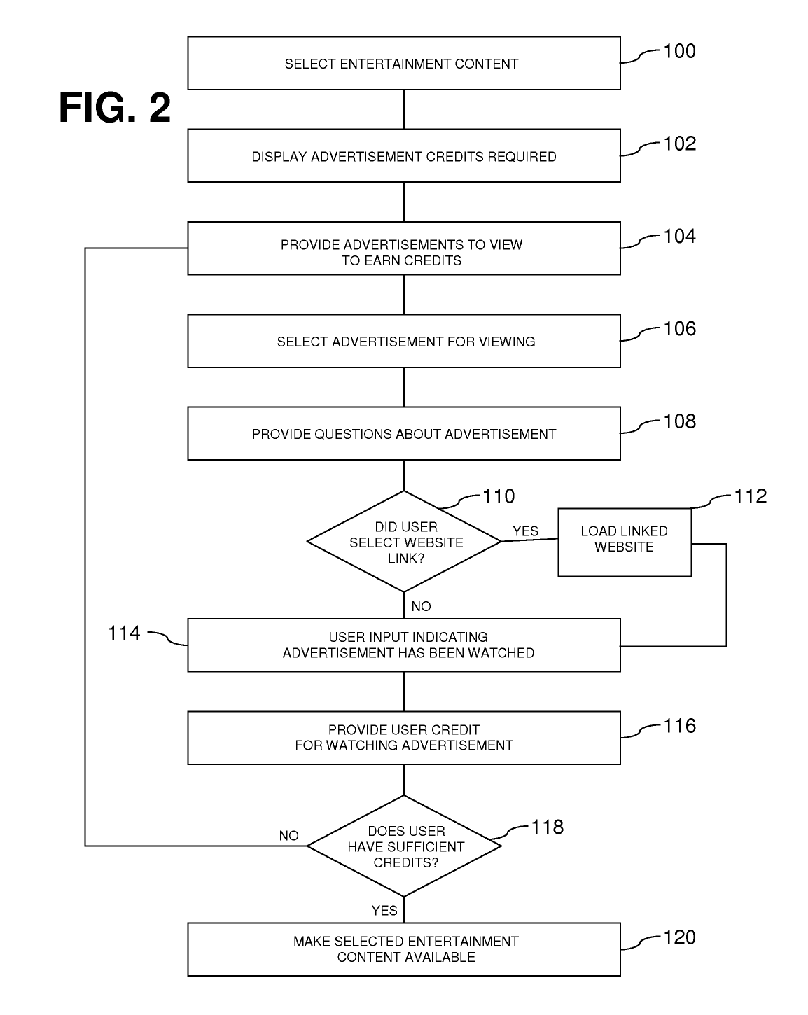

FIG. 2 shows a flow chart of a user interacting with the user interface 12 of the on-line video entertainment and advertising system 10. The user selects content, such as entertainment content, they wish to view from a website at step 100. At step 102, the on-line video entertainment and advertising system 10 displays a number of advertisement credits, or commercial credits, required to watch the selected content advertising-free. Step 104 shows the user presented with a plurality of advertisement that may be watched to earn credits towards viewing the selected content. The user selects an advertisement for viewing at step 106 and the selected advertisement is played. Optionally, the user may answer questions about the advertisement at step 108, such as whether they were entertained by the advertisement, or whether the product in the advertisement appeals to them. It is contemplated that a user will be provided with additional credits if they answer questions relating to the advertisement selected for viewing.

Regardless of whether a user chooses to answer questions about the advertisement, step 110 determines whether the user has selected a website link to the desired viewing content, such as a hyperlink, provided on the screen while the advertisement is presented. If the user selects the website link, the linked website is loaded at step 112. It is contemplated that a linked website will typically load in a separate browser window, and that the video advertisement being played is be paused until the user returns and resumes the video advertisement. Next, a user is presented with an advertisement credit screen that requires a user input indicating that the advertisement is complete, as shown at step 114. Once the user input is detected, a credit for watching the advertisement is provided to the user at step 116. A user may have to supply the input within a set period of time for the system to provide the user with a credit for watching the advertisement.

Once the user has earned a credit by watching an advertisement, the on-line video entertainment and advertising system 10 determines at step 118 whether the user has sufficient credits to watch the previously selected content. If the user does not have enough credit, the process returns to step 104 for the user to select another advertisement and earn credits as described in connection with step 106 to step 116. This cycle continues until a user has a sufficient number of credits to watch the content selected at step 100. At step 120 the content selected is made available to the user for viewing, without any additional advertisements, as the user has earned the number of credits required for that content. It is contemplated that the content is only available for a predetermined period of time, such as for a twenty-four hour period.

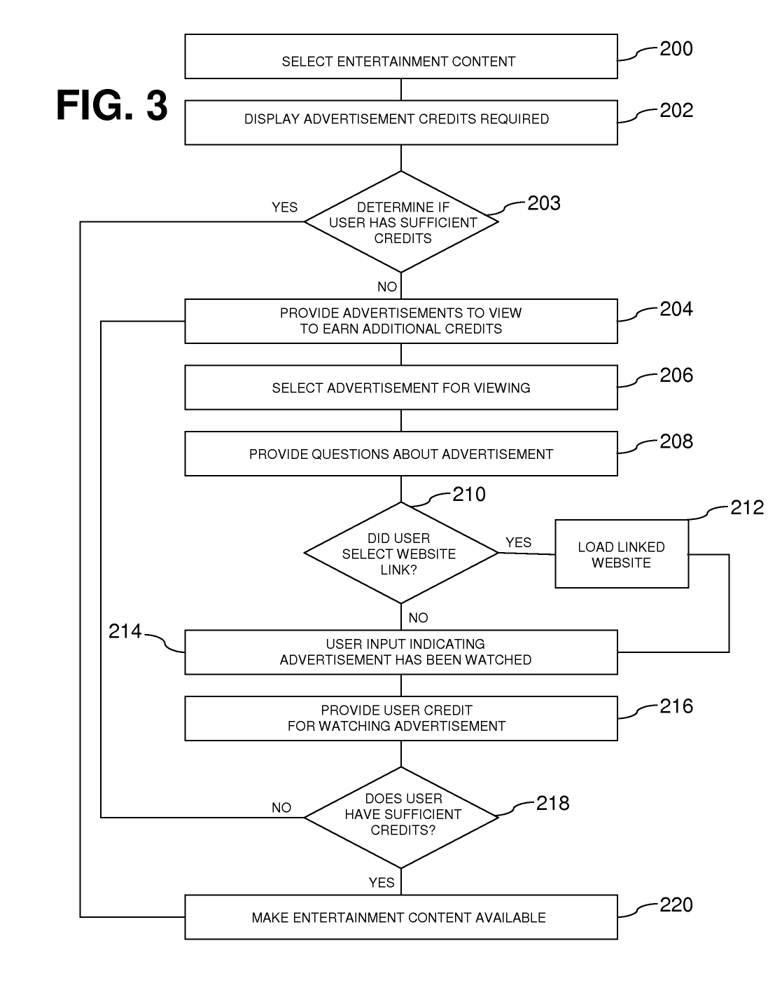

It is also contemplated that a user may log-in to the system to earn credits that may be utilized at a later time. FIG. 3 shows a flow chart of a user interacting with the user interface 12 of the on-line video entertainment and advertising system 10 where a user has logged into the system. The user selects content, such as entertainment content, they wish to view from a website at step 200. At step 202, the on-line video entertainment and advertising system 10 displays a number of commercial credits required to watch the selected content. Step 203 determines whether the user has sufficient credits in their account to watch the selected content. If the user has sufficient credits, the selected content is made available to the user as shown at step 220. If the user does not have sufficient credits, or simply wishes to earn additional credits, step 204 shows the user presented with a plurality of advertisement that may be watched to earn credits towards viewing the selected content. The user selects an advertisement for viewing at step 206 and the selected advertisement is played. Optionally, the user may answer questions about the advertisement at step 208, such as whether they were entertained by the advertisement, or whether the product in the advertisement appeals to them. It is contemplated that a user will be provided with additional credits if they answer questions relating to the advertisement selected for viewing.

Regardless of whether a user chooses to answer questions about the advertisement, step 210 determines whether the user has selected a website link to the serried viewing content, such as a hyperlink, provided on the screen while the advertisement is presented. If the user selects the website link, the linked website is loaded at step 212. It is contemplated that a linked website will typically load in a separate browser window, and that the video advertisement being played is be paused until the user returns and resumes the video advertisement. Next, a user is presented with an advertisement credit screen that requires a user input indicating that the advertisement is complete, as shown at step 214. Once the user input is detected, a credit for watching the advertisement is provided to the user at step 216. A user may have to supply the input within a set period of time for the system to provide the user with a credit for watching the advertisement.

Once the user has earned a credit by watching an advertisement, the on-line video entertainment and advertising system 10 determines at step 218 whether the user has sufficient credits to watch the previously selected content. If the user does not have enough credit, the process returns to step 204 for the user to select another advertisement and earn credits as described in connection with step 206 to step 216. This cycle continues until a user has a sufficient number of credits to watch the content selected at step 200. At step 220 the content selected is made available to the user for viewing, without any additional advertisements, as the user has earned the number of credits required for that content. It is contemplated that the content is only available for a predetermined period of time, such as for a twenty-four hour period.

In addition to earning credits for watching advertisements, answering questions about the advertisements, or visiting a website associated with an advertisement, it is also contemplated that a user may earn credits by sending links containing advertisements to acquaintances. For example, a user may email a link containing an advertisement to one of their acquaintances, and once the acquaintance views the advertisement, the user will also receive a credit for the fact that the acquaintance viewed the advertisement.

Thus, a user has the ability to earn credits to watch selected content without any advertisements interrupting the content either slightly before watching the content and without having to log-in to the on-line video entertainment and advertising system 10, or the user may obtain credits at convenient times, such as at lunch, while taking public transportation, a break at work, or any convenient time when the user only has sufficient time for a few minutes of viewing, and then at a later time redeem those credits previously earned to watch the selected content.

Additionally, it is contemplated that a user may create a user specific account in order to earn credits for later use as described in connection with FIG. 3. In such an embodiment, the user may be asked to provide certain demographic information, such as their age, gender, whether they are a parent or legal guardian, what hobbies they have, and other questions about their interests. This demographic information may be used by the on-line video entertainment and advertising system 10 to present the user with advertisement that are likely to be of interest based on the demographic information. For instance, if a user indicates that they travel frequently, airline and hotel advertisements may be presented. If the user indicates that they have an infant, advertisements related to diapers and baby formula may be presented.

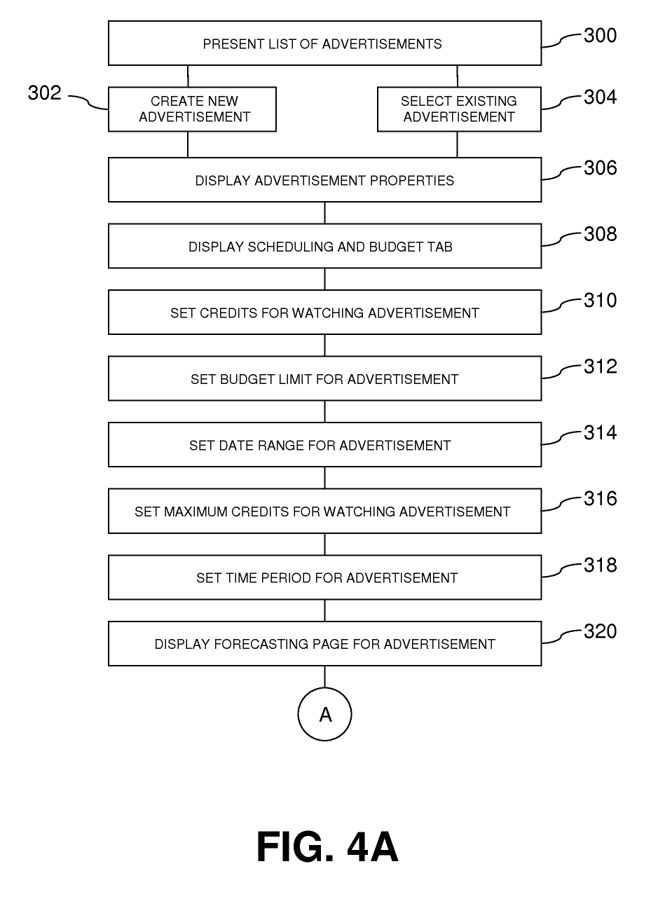

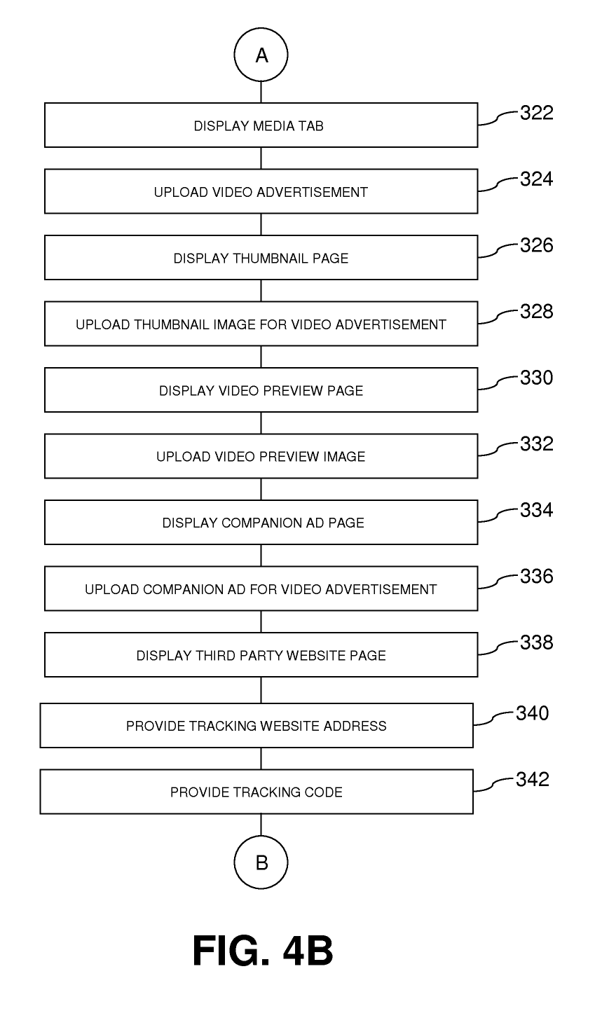

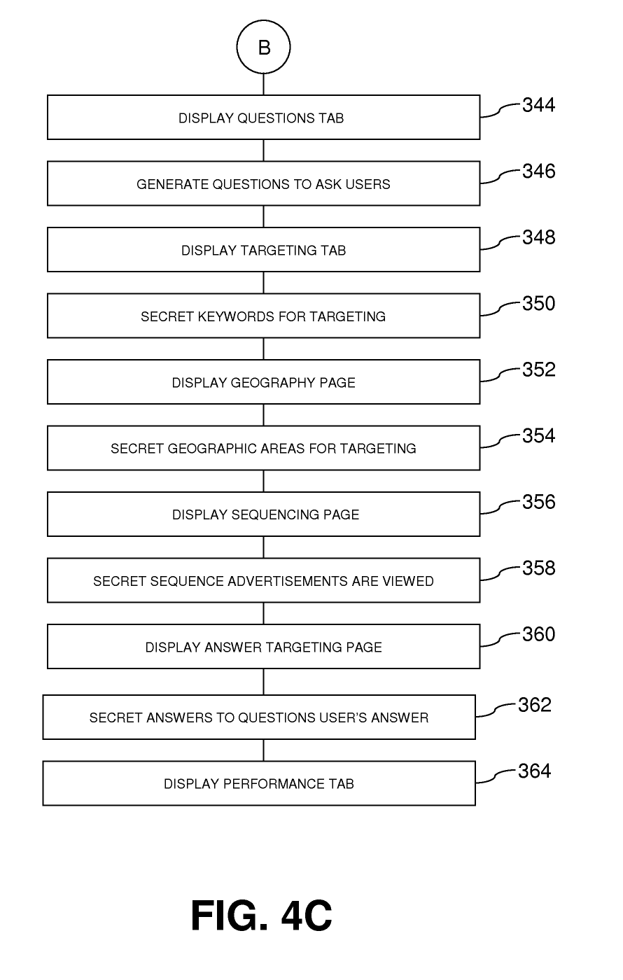

FIGS. 4A-4C show a flow chart of the advertiser interface 16 of the on-line video entertainment and advertising system 10. A representative of an advertiser or advertising agency is presented with a list of active advertisements at step 300. The representative is able to create a new advertisement for uploading to the on-line video entertainment and advertising system 10 at step 302, or select a particular existing advertisement already on the on-line video entertainment and advertising system 10 at step 304. The representative may select a particular existing advertisement at step 304 by choosing it from the list of active advertisements, or the representative may search based on properties of the advertisement such as the title of the advertisement, the product or service being advertised, or the manufacturer or provider of the product or service being advertised. Once a particular existing advertisement or a new advertisement is selected, a general advertisement properties tab is displayed at step 306. The general advertisement properties tab may include information such as an internal name of the advertisement, an external label for the advertisement, a description of the advertisement, files associated with the advertisement, such as video of the advertisement, pictures of a product or service being advertised, information about the product or service being advertised, media plans for the product or service being advertised, and the like.

Once the user has entered any information to the general advertisement properties tab, a scheduling and budget tab may be displayed at step 308. The scheduling and budget tab may have multiple pages, such as a budgeting page, a scheduling page, and a forecasting page. The budgeting page of the scheduling and budgeting tab allows a representative to select a number of credits a user will receive for viewing the advertisement, select a number of credits a user will receive for answering questions related to the advertisement, determine the maximum number of times the advertisement may be viewed on the on-line video entertainment and advertising system 10, and set a total budget displaying the advertisement on the on-line video entertainment and advertising system 10. For instance, if an advertiser wishes to have the advertisement viewed frequently, they may decide to provide multiple credits to a user for viewing the advertisement. The limit on the number of times the advertisement may be viewed and the budget for the advertisement allow an advertiser to set their maximum expenditure for a particular advertisement. In this way, an advertiser may limit their financial exposure to the content provider should a particular advertisement become particularly popular. Thus, a representative may determine the number of credits a user receives for watching an advertisement at step 310, the representative may also set a budget limit for the advertisement at step 312.

The scheduling page of the scheduling and budget tab allows the representative to determine calendar dates when the advertisement is available to a user. The representative may select a range of dates that an advertisement is available, a number of times a particular user may access the advertisement for credit on the on-line video entertainment and advertising system 10, and control the time of day the advertisement is available. For instance, if the advertisement relates to breakfast items at a restaurant, the advertisement may only be available from 7:00 pm until 10:00 am when a user may be most likely to be thinking of breakfast. A date range when the advertisement is available is provided at step 314. Step 316 sets a maximum number of credits a particular advertisement may provide a user. A time the advertisement is available may also be set at step 318.

The forecasting page of the scheduling and budgeting tab shows the representative the number of times the advertisement has been viewed and provides an estimate as to when the budget for the advertisement will be consumed. Thus, the representative may adjust the budget, or adjust the number of credits the advertisement provides a user, the number of credits that may be earned from an advertisement, the time of day the advertisement is available, or any other aspect of the advertisement to adjust the date when the budget for the advertisement will be consumed. Step 320 displays a forecast date when the budget for the advertisement will be exhausted.

A media tab is displayed to the representative at step 322. The media tab has a plurality of pages such as a video page, a thumbnail image page, a video preview page, a companion ad page, a hyperlink page, and a tracking page. The video page of the media tab of the on-line video entertainment and advertising system 10 allows the representative to upload the advertisement into a video slide of the on-line video entertainment and advertising system 10. The advertisement uploaded may be a new advertisement, or may be a modified version of an existing advertisement. A representative may upload a new or modified video at step 324. The media tab has a thumbnail image page that is displayed at step 326. The thumbnail image page allows the representative to upload a new or modified image that is used to identify the advertisement in a queue of advertisements at step 328.

The media tab additionally has a video preview page that is displayed to the representative at step 330. The video preview page allows the representative to upload a new or modified preview image that is displayed when a user selects the advertisement from the queue as shown at step 332. A companion advertisement page is also provided on the media tab and may be displayed to the representative at step 334. The companion advertisement page allows the representative to upload a new or modified still advertisement that may be displayed to a user as shown at step 336. A third party website page exists on the media tab and is displayed to the representative at step 338. The third party website page allows the representative to provide tracking websites that insert a tracking code to each advertisement that allows a provider of the advertisement to receive information about the advertisement at step 340, such as a number of times and advertisement is started, the number of times an advertisement is repeated, the number of times a user completes a viewing of the advertisement, the number of times companion advertisements are viewed, and the number of times a user visits a website from the advertisement. Finally the media tab contains a conversion tracking page that is displayed to the representative at step 342. The conversion tracking page allows the representative to provide or modify a code that allows a user to be tracked when they visit a website from an advertisement as shown at step 338.

The advertiser interface 16 also has a questions tab that may be accessed by the representative as shown at step 344. The questions tab allows the representative to generate a number of questions that may be asked to the user as shown at step 346. For example, the question tab allows a representative to ask a user to rank the advertisement, ask the user questions about the product in the advertisement, or to rate the product in the advertisement, etc.

A targeting tab is also contained in the advertiser interface 16 that is displayed to the representative at step 348. A keyword targeting page of the targeting tab allows the representative to select a number of key words at step 350 that will display the advertisement on a queue to the user when they enter that key word. For example, an advertisement for an automobile may be placed on the queue if the user searches for automobiles. The targeting tab also displays a geography page to the user at step 352. The geography page allows the representative to select geographic areas where users may live and have the advertisement placed on the queue as shown at step 354. For example, an advertisement may be made available to users only if they are within a specified state, region, city, area code, or zip code. The targeting tab further has a sequencing page that is displayed to the representative at step 356. The sequencing page allows the representative to create an order that advertisements are displayed to the user as shown at step 358. The sequencing page allows the representative to allow a second advertisement to be placed on the user's queue only if a first advertisement has been viewed by the user. Thus, the advertisements may tell a story that is presented in a certain order, or may build on each other, and the representative can ensure that a user sees the advertisements in the desired order.

Finally, the targeting tab has an answer targeting page that is displayed to the representative at step 360. The answer targeting page allows the representative to select answers to questions that are answered by users to place advertisements into the user's queue at step 362. For example, an automobile advertisement may be placed in the queue of a user who indicates they are interested in purchasing a new car.

A performance tab of the advertiser interface 16 is displayed to the representative at step 364. The performance tab has an advertisement performance page, and a key performance page. The advertisement performance page allows the representative to obtain a variety of information about a particular advertisement, such as the number of times the advertisement was viewed, the number of times a user answered questions about the advertisement, and how user's have rated the advertisement. The key performance page of the performance tab provides the representative with information about a particular advertisements performance when in a user's queue as shown at step 366. For instance, the key performance page may indicate the percentage of times the advertisement is viewed based on its position in the queue. This information may allow the representative to modify settings on the targeting tab to improve the positioning of the advertisement within a user's queue, so that the advertisement may be viewed more often.

The advertising interface 16 has a report module that allows a representative to obtain data regarding a number of advertisements. The report module allows the representative to learn which advertisements are most effective in certain demographics, which advertisements receive the highest number of links to outside websites, which advertisements generate the most responses to questions, and other information about the advertisements.

A budget module is also provided on the advertising interface 16. The budget module allows the representative to set a budget for an advertisement. The representative may set the price per viewing of each advertisement, indicate an entity to be billed for the advertisements that are viewed, provide information about an amount of an initial budget that remains, and the number of times an advertisement has been viewed.

Finally, the advertising interface 16 has an administration module. The administration module allows the representative select individuals who may also access the advertising interface. The administration module also allows the representative to create custom geographic regions for targeting advertisements. For example, if a restaurant has a location in Las Vegas and New York, the representative may select areas near New York and areas near Las Vegas to display the advertisements.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that a control system may be implemented in hardware to effectuate the method. The control system can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

When the control system is implemented in software, it should be noted that the control system can be stored on any computer readable medium for use by or in connection with any computer related system or method. In the context of this document, a computer-readable medium can be any medium that can store, communicate, propagate, or transport the program for use by or in connection with the instruction execution system, apparatus, or device. The computer readable medium can be, for example, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). The control system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A method of providing video entertainment content on-line without advertising interruptions of the video entertainment content comprising the steps of:
receiving a user request to provide video entertainment content;
determining an amount of credits required to display the entertainment content;
informing the user of the amount of credits required to view the video entertainment content;
providing a list of advertisements the user may watch to earn credits;
determining whether the user has watched an advertisement and earned credits; and
allowing the user access to the video entertainment content without advertising interruptions when the user has the amount of credits required to display the entertainment content.

2. The method of claim 1, further comprising determining a number of credits stored within a user's account before providing a list of advertisement the user may watch to earn credits.

3. The method of claim 2, wherein the credits stored in the user's account were present before receiving the user request to provide video entertainment content.

4. The method of claim 1, further comprising receiving a user input selecting an advertisement from the list of advertisement, and providing the user with the advertisement selected from the list of advertisements.

5. The method of claim 4, wherein the step of determining whether the user has watched an advertisement and earned credits requires a user input after providing the user with the advertisement selected from the list of advertisements.

6. The method of claim 5, wherein the user input after providing the user with the advertisement must occur within a predefined time limit of providing the user with the advertisement.

7. The method of claim 1, wherein the step of allowing the user access to the video entertainment content has a predefined duration.

8. The method of claim 1 further comprising displaying questions to the user about the advertisement, and providing a credit to the user upon receipt of a user response to the question about the advertisement.

9. The method of claim 1 further comprising, providing a hyperlink to website related to the advertisement.

10. A method of controlling advertising content for an on-line video entertainment and advertising system providing video entertainment content without advertising interruptions comprising the steps of:
storing a video advertisement within a memory associated with an on-line video entertainment and advertising system the system;
receiving an input indicative of a number of credits to provide a user that watched the video advertisement;
scheduling a time period that video advertisement is available for viewing;
receiving questions to ask a user each time a user watched the video advertisement; and,
receiving user targeting information for the video advertisement.

11. The method of claim 10 further comprising storing a companion advertisement related to the video advertisement within the memory associated with an on-line video entertainment and advertising system the system.

12. The method of claim 10 further comprising receiving an input indicative of a maximum budget for the video advertisement.

13. The method of claim 10, wherein the time period is a range of dates.

14. The method of claim 10, wherein the time period is a range of times of a day.

15. The method of claim 10, wherein the time period is a range of dates and a range of times of a day.

16. The method of claim 10, wherein the targeting information is a keyword a user enters.

17. The method of claim 10, wherein the targeting information is a geographic location of a user.

18. The method of claim 10, wherein the targeting information is responses to questions a user answers after watching a video advertisement.

19. A physical computer program product, comprising a computer usable medium having an executable computer readable program code embodied therein, the executable computer readable program code for implementing a method of providing entertainment content over a computer network comprising the steps of:
receiving a user input selecting video entertainment content to provide;
determining if a user has sufficient advertising viewing credits to view the selected video entertainment content selected without viewing advertising during a presentation of the entertainment content;
presenting access of the video entertainment content to the user without advertising if the user has sufficient credits;
generating a message to the user of an amount of advertising viewing credits needed to view the video entertainment content without viewing advertising during a presentation of the video entertainment content if the user lacks sufficient credits; and
allowing the user to accumulate additional advertising viewing credits if the user lacks sufficient advertising viewing credits to view the video entertainment content without viewing additional advertising during the presentation of the entertainment content.

20. The method of claim 19 wherein the step of allowing the user to accumulate additional advertising viewing credits provides the user with a plurality of advertising content for viewing.

21. A method of providing video entertainment content on-line without advertising interruptions of the video entertainment content comprising the steps of:
receiving a user request to provide video entertainment content;
determining an amount of credits required to display the entertainment content;
determining whether the user has watched an advertisement and earned credits; and
allowing the user access to the video entertainment content without advertising interruptions when the user has the amount of credits required to display the entertainment content.
